(19) United States
(12) Patent Application Publication
(10) Pub. No.: US 2011/0148864 A1
(43) Pub. Date: Jun. 23, 2011

(54) METHOD AND APPARATUS FOR CREATING HIGH-QUALITY USER-CUSTOMIZED 3D AVATAR

(75) Inventors: Ji-Hyung LEE, Daejeon (KR); Yoon-Seok Choi, Daejeon (KR); Do-Hyung Kim, Daejeon (KR); Il-Kyu Park, Daejeon (KR); Young-Mi Cha, Busan (KR); Jeung-Chul Park, Jeonju (KR); Bon-Ki Koo, Daejeon (KR)

(73) Assignee: Electronics and Telecommunications Research Institute, Daejeon (KR)

(21) Appl. No.: 12/965,675

(22) Filed: Dec. 10, 2010

(30) Foreign Application Priority Data
Dec. 18, 2009 (KR) 10-2009-0126710

(51) Int. Cl. G06T 15/00

(52) U.S. Cl. 345/419

(57) ABSTRACT

Disclosed herein is a method and apparatus for creating a 3D avatar. The method of creating a three dimensional (3D) avatar includes receiving body information of a user and storing the body information in a DataBase (DB), and creating a 3D avatar for the user by modifying standard data, predetermined based on body information about various persons and stored in the DB, based on the body information of the user.

### CROSS REFERENCE TO RELATED APPLICATIONS

This application claims the benefit of Korean Patent Application No. 10-2009-0126710 filed on Dec. 18, 2009, which is hereby incorporated by reference in its entirety into this application.

### BACKGROUND OF THE INVENTION

1. Field of the Invention

The present invention relates generally to a method and apparatus for creating a three-dimensional (3D) avatar, and, more particularly, to a method and apparatus for creating a 3D avatar, which are capable of more easily and quickly creating high-quality 3D avatars used in 3D content.

2. Description of the Related Art

Recently, 2D video-based User-Created Content (UCC) is creating a boom. The UCC is posted and shared in Internet space. Producers who create the UCC want their UCC to be different from the UCC created by other producers. A lot of attempts have been made to meet this objective. One of these attempts is UCC using recent 3D technology.

A representative example of UCC using 3D technology is Machinima. Machinima enables graphics data to generate a one episode video clip using a game engine. A lot of 3D characters are inevitably used in Machinima, but do not resemble their producers or users. In contrast, in Second Life (i.e., an on-line Internet 3D community site), 3D characters (i.e., 3D avatars) resembling users are used. In order to create such an avatar, some data is provided, and an avatar is created by a simple combination of the data. Since the term “avatar” originally means a 2D or 3D character representing a user, most of the users want their avatars to resemble them. It is, however, difficult to create an avatar resembling the user, or a high-quality 3D avatar, by performing such a combination.

Furthermore, high-quality 3D characters have been used even when video content, such as an existing movie, is created. For this purpose, a character resembling a real human has been generated using the latest in 3D graphics technology. A tremendous cost and time expenditure is, however, required to generate such a character. There is a demand for a method of easily and quickly creating a 3D avatar, which is different from existing methods, in order for a user to produce content that uses a high-quality avatar which resembles the user.

### SUMMARY OF THE INVENTION

The present invention is intended to create a high-quality 3D avatar, which resembles oneself; unlike the low-quality 3D avatars that are being used currently at the existing game level. For this purpose, the latest in 3D graphics technology is used, but a user's input is minimized so that the time that the process takes to create one can be reduced and the processes of creating an avatar are closely connected and processed quickly.

There is a need for two elements so that a user receives the impression that a 3D avatar resembles the user. The first element is that the face of the 3D avatar resemble the user himself or herself. For this purpose, the use of a photograph of the user himself or herself is insufficient and the face geometry data of a 3D avatar must resemble the user. The second element is the bodily shape of the user. In order for the body of the 3D avatar to resemble the user's bodily shape, information about the height and volume of the body of the user must be taken into consideration.

Furthermore, in order to create high-quality 3D avatars, unlike 3D avatars used in existing games or other Internet services, first, a large amount of data is required. That is, the size of data, such as 3D geometry data or a texture map, must be large, and additional data is required to achieve high quality. For example, in order to implement the natural skin of a 3D avatar, a Bidirectional Reflectance Distribution Function (hereinafter referred to as a ‘BRDF’) and subsurface scattering data are required. The BRDF is a value obtained by measuring the influence of illumination on the face data of a user, and the subsurface scattering data is data obtained by measuring the skin characteristics of a real human. A more realistic avatar can be represented by a 3D avatar using the BRDF or the subsurface scattering data.

Handling such a large-amount of data, however, requires a long amount of time and a lot of effort. If the work is substituted into a process of creating 3D characters used in a field, such as the existing movie field, 3D scanning is performed to generate a user's geometry and real measurements are taken to obtain a BRDF or subsurface scattering data.

In the present invention, a DataBase (DB) is previously organized by obtaining high-quality data of various persons in order to reduce the time that it takes to perform such work. Such a DB is established in order to quickly perform a process of creating avatars.

Accordingly, the present invention has been made keeping in mind the above problems occurring in the prior art, and an object of the present invention is to quickly create an avatar, resembling a user, while maintaining quality high by obtaining a minimum of data on a user in order to create the 3D avatar and modifying and using the minimum data.

In order to achieve the above object, the present invention provides a method of creating 3D avatars, including a body information input step of receiving body information of a user and storing the body information in a DB; an avatar creation step of creating a 3D avatar for the user by modifying standard data, predetermined based on body information about various persons and stored in the DB, on a basis of the body information of the user.

The method may further include a search step of searching the DB for standard data corresponding to the user and selected from all the standard data predetermined based on body information about various persons and stored in the DB, based on the body information of the user.

The body information of the user may include user information about one or more of a photograph, gender, height and weight of the user.

The standard data may include additional data which are at least one of 3D geometry, a texture map, a Bidirectional Reflectance Distribution Function (BRDF), and subsurface scattering data.

The avatar creation step may include a face modeling step of modeling a face of the 3D avatar for the user using standard data for a face, selected from among the standard data, based on the body information of the user; and a body modeling step of modeling a body of the 3D avatar for the user using standard data for a body, selected from among all the standard data, based on the body information of the user.

The face modeling step may include a feature point extraction step of extracting feature points of a face of the user based on face photographs of the user; a texture data creation step of generating texture data of the user to be mapped to the face of the 3D avatar based on the extracted feature points of the face; and an avatar face creation step of comparing the texture data of the user with the standard data for the face and generating the face of the 3D avatar for the user by modifying the standard data for the face based on a result of the comparison.

The body modeling step may include generating the body of the 3D avatar for the user by modifying the standard data for the body based on the height and weight of the user.

The avatar face creation step may include generating the face of the 3D avatar for the user by calculating the difference between the extracted feature points of the face and texture data used in the standard data for the face and modifying the standard data for the face based on the difference.

The texture data creation step may include calculating the difference between the feature points of the face and texture data used in the standard data for the face and generating the texture data of the user based on the difference.

The method may further include an animation step of applying motions to the 3D avatar for the user.

The method may further include a rendering step of performing rendering in order to give a feeling of reality to the 3D avatar for the user.

Furthermore, it is preferred that the method further include a rendering step of performing rendering so that a feeling of reality is given to the 3D avatar for the user.

In order to achieve the above object, the present invention provides an apparatus for creating 3D avatars, including an avatar creation unit for creating a 3D avatar for the user by modifying standard data, predetermined based on body information about various persons and stored in the DB, based on the body information of the user.

The avatar creation unit may search the DB for standard data corresponding to the user, selected from among all the standard data predetermined based on body information about various persons and stored in the DB, based on the body information of the user.

The body information of the user may include user information about one or more of the photograph, gender, height, and weight of the user.

The standard data may include additional data which are at least one of 3D geometry, a texture map, a BRDF, and subsurface scattering data.

The avatar creation unit may include a face modeling unit for modeling a face of the 3D avatar for the user by using standard data for a face, selected from among all the standard data, based on the body information of the user; and a body modeling unit for modeling a body of the 3D avatar for the user by using standard data for a body, selected from among all the standard data, based on the body information of the user.

The face modeling unit may extract feature points of a face of the user based on face photographs of the user, generate texture data of the user to be mapped to the face of the 3D avatar based on the extracted feature points of the face, compare the texture data of the user with the standard data for the face, and generate the face of the 3D avatar for the user by modifying the standard data for the face based on a result of the comparison.

The body modeling unit may generate the body of the 3D avatar for the user by modifying the standard data for the body based on the height and weight of the user.

The apparatus may further include an animation unit for applying motions to the 3D avatar for the user.

The apparatus may further include a rendering unit for performing rendering in order to give a feeling of reality to the 3D avatar for the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating an example of the configuration of an apparatus to which a method of creating 3D avatars according to the present invention is applied;

FIG. 2 is a diagram illustrating a method of constructing a BRDF DB by measuring a user's BRDF;

FIG. 3 is a diagram illustrating the sequence of creating a 3D avatar using the method of creating 3D avatars according to the present invention; and

FIG. 4 is a diagram illustrating the sequence of the method of creating 3D avatars according to the present invention.

### DESCRIPTION OF THE PREFERRED EMBODIMENTS

Reference now should be made to the drawings, in which the same reference numerals are used throughout the different drawings to designate the same or similar components.

An apparatus and method for creating 3D avatars according to embodiments of the present invention will be described below with reference to the accompanying drawings.

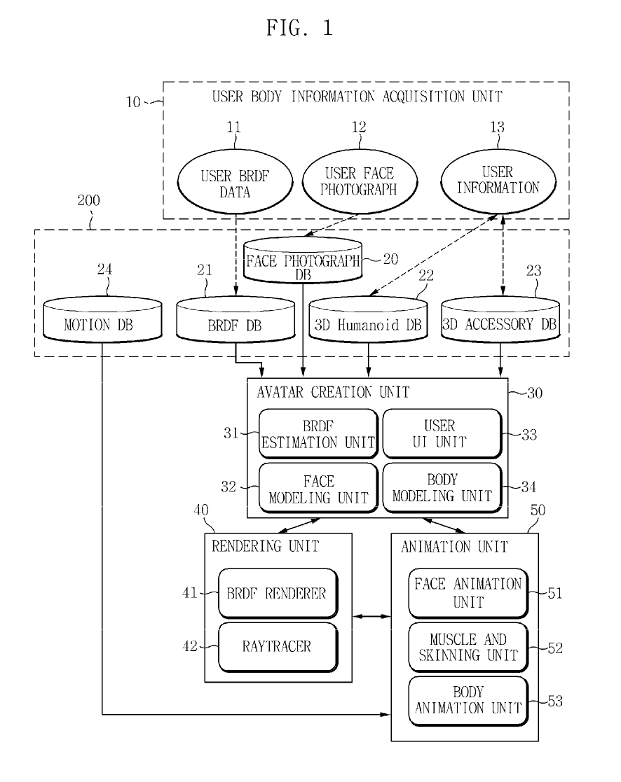

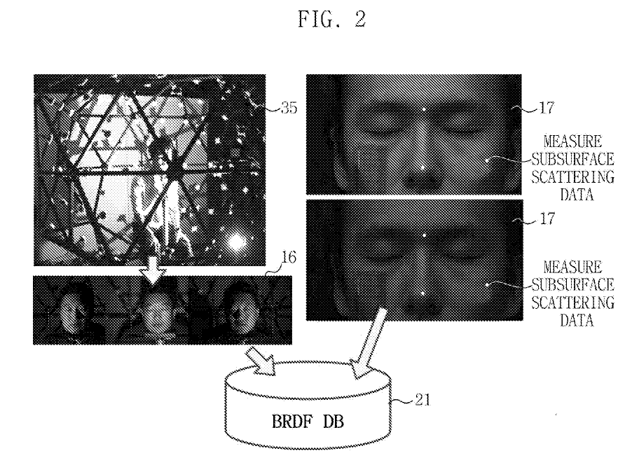

FIG. 1 is a diagram illustrating an example of the configuration of an apparatus to which a method of creating 3D avatars according to the present invention is applied, and FIG. 2 is a diagram illustrating a method of constructing a BRDF DB by measuring a user's BRDF. Here, reference numeral 16 denotes the measured/estimated BRDF data of a user, and reference numeral 17 denotes data of a diagram of measured subsurface scattering data of a user.

The recent developments in computer and content creation technology have increased the demand for user-customized content. Among these pieces of user-customized content, 3D technology-based content frequently contains 3D characters (i.e., avatars) representing users. Computer games are a representative of the content in which such avatars appear. Since users want their avatars to resemble them, computer games enable their avatars to be easily created. However, there are limitations on the quality and representation of avatars. In contrast, the production of a 3D character used to produce high-quality video content, such as a movie, is done in high quality with existing computer graphics technology, but this production is expensive and the production period is long. The present invention proposes a method of easily and quickly producing high-quality 3D characters (i.e., avatars).

Referring to FIG. 1, the apparatus for creating 3D avatars, to which a method of creating a high-quality user-customized 3D avatar, according to the present invention includes an avatar creation unit 30 for creating a 3D avatar for a specific user by modifying standard data, predetermined on the basis of information about the bodies of various persons and stored in a DataBase (DB) 200, on the basis of information about the body of the specific user, an animation unit 50 for applying motions to the 3D avatar for the specific user, and a rendering unit 40 for performing rendering in order to give a feeling of reality to the 3D avatar for the specific user.

In the present invention, it is preferred that the 3D avatar creation apparatus further include a user body information acquisition unit 10 for receiving information about the bodies of users and the DB 200 for storing the information about the bodies of users and standard data for creating a 3D avatar. The user body information acquisition unit 10 may have any configuration as long as it is capable of receiving body information from users. In the present invention, although a camera or a key input unit is used as input means, the present invention is not limited thereto.

It is preferred that the user body information include information about one or more of the photograph, gender, height, and weight of the user. For example, the user body information acquisition unit 10 receives two sheets of photographs from a user and stores the user photographs in the DB 200. It is preferred that face photographs 12 of a user include the front and side photographs of the user's face. The acquired photographs are stored in a face photograph DB 20. Thereafter, the user body information acquisition unit 10 receives user information 13 from the user. The user information 13 includes the user's height and weight.

The DB 200 stores standard data for creating a 3D avatar and a user's body information. It is preferred that the DB 200 include the face photograph DB 20, a 3D humanoid DB 22, a 3D accessory DB 23, a BRDF DB 21, and a motion DB 24. A detailed description thereof will be given in detail later.

The avatar creation unit 30 creates a 3D avatar for a specific user by modifying standard data, related to the information about the bodies of various persons and stored in the DB 200, on the basis of information about the body of the specific user. The avatar creation unit 30 includes a BRDF estimation unit 31, a User Interface (UI) unit 33, a face modeling unit 32, and a body modeling unit 34. The avatar creation unit 30 will now be described in detail.

Furthermore, the avatar creation unit 30 searches the DB 200, in which standard data related to information about the bodies of various persons is stored, for standard data for a specific user, on the basis of information about the body of the specific user. In other words, the avatar creation unit 30 searches for standard data for the specific user from among the standard data, stored in the DB 200 and related to information about the bodies of various persons, on the basis of body information about the specific user. For example, the avatar creation unit 30 may fetch standard 3D face geometry 25 and a standard 3D body geometry 26 corresponding to a 3D avatar from the 3D humanoid DB 22 on the basis of the acquired height and weight of a user. It is assumed that the 3D humanoid DB 22 store two standard face geometries for each gender and a total of 18 standard body geometries for each gender, as well as height (i.e., tall, average, and short), and obesity (i.e., high, middle, and low). In this case, the avatar creation unit 30 searches for the closest data on the basis of the information about the body of a user and uses the retrieved data. Furthermore, the 3D accessory DB 23 stores wigs and peripheral accessories. The avatar creation unit 30 may select and use a desired wig and peripheral accessories according to the selection of the user.

Furthermore, when user BRDF data 11 exists, the avatar creation unit 30 stores the BRDF data 11 in the BRDF DB 21. The user BRDF data 11 can be measured using specially designed BRDF measurement equipment 35, and thus the public does not usually have BRDF values. Accordingly, the BRDF estimation unit 31 searches the BRDF DB 21 for the closest BRDF value on the basis of a skin tone, and uses a retrieved BRDF value.

Referring to FIG. 2, the BRDF measurement equipment 35 has a spherical structure configured to have 156 LEDs arranged therein and a camera configured to take pictures when the 156 LEDs are sequentially turned on. The BRDF measurement equipment 35 measures the distribution of the scattered light exhibited on the face of a user onto which illumination of the LEDs has been radiated. The measurement equipment 35 is fabricated on the basis of information known to the existing academic world, and is used in the present invention.

The BRDF DB 21 further stores subsurface scattering data 17. The BRDF measurement equipment 35 obtains the subsurface scattering data 17 by projecting a specific pattern without using the LEDs as a light source. Since the skin has a multi-layer structure, the transmission, scattering and reflectivity of light generated within the skin layer are measured and used. If rendering is performed using the BRDF data 16 and the subsurface scattering data 17, a video of the skin better than that provided by the existing computer graphics can be obtained, so that such rendering is indispensable to create a high-quality avatar.

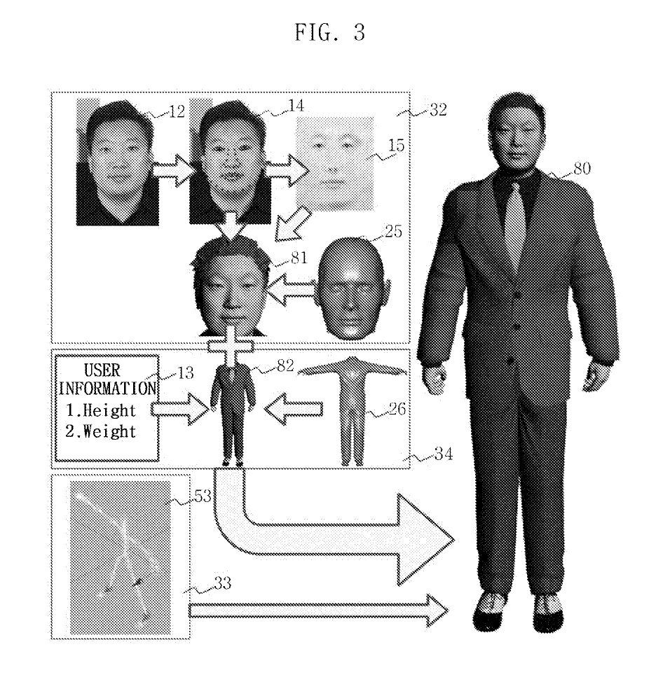

FIG. 3 is a diagram illustrating the sequence of creating a 3D avatar using the method of creating 3D avatars according to the present invention. Here, reference numeral 12 denotes a user's face photograph, reference numeral 14 denotes a region extracted from the user's face photograph, reference numeral 15 denotes an example of a face mapping image (i.e., texture) generated using the region 14, reference numeral 25 denotes an example of standard 3D face geometry retrieved from the 3D humanoid DB 22, reference numeral 26 denotes an example of standard 3D body geometry retrieved from the 3D humanoid DB 22, reference numeral 80 denotes an example of a created 3D avatar, reference numeral 81 denotes an example of 3D face geometry 25 modified in accordance with a user, and reference numeral 82 denotes an example of 3D body geometry 26 that has been modified on the basis of user information.

The method of creating 3D avatars will now be described in more detail with reference to FIG. 3. When the standard 3D face and body geometries 25 and 26 are prepared on the basis of the BRDF data 16, the subsurface scattering data 17, the face photographs 12 and the user information 13 for a user, the avatar creation unit 30 creates a 3D avatar resembling the user. That is, 3D avatar modeling is started by an intuitive UI 33, the face modeling unit 32 and the body modeling unit 34. First, the feature points 14 of the face of the user are extracted on the basis of the face photographs 12 of the user. In the present invention, an Active Appearance Model (AAM) (i.e., the existing face feature point extraction method) is used. The texture data (i.e., the face mapping image) 15 mapped to the face of a 3D avatar is generated on the basis of the extracted feature points 14. The texture data 15 is generated by calculating the difference between the extracted feature points 14 and feature points extracted from texture data which is used in the standard 3D face data (i.e., a standard 3D face geometry) 25 retrieved from the 3D humanoid DB 22. The difference is used to produce the 3D face geometry 81 for the user by modifying the standard 3D face data 25.

Thereafter, the avatar creation unit 30 scales up or down the 3D body data (i.e., the 3D body geometry) 26, selected on the basis of the user information, on the basis of the user's height and weight. For example, in Korea, the 3D body data is scaled up or down on the basis of a standard body size that is calculated using data from a survey conducted every 5 years. Consequently, the 3D body geometry 82 having a bodily shape relatively close to the user's bodily shape is produced.

Thereafter, the avatar creation unit 30 creates a user avatar by combining the 3D body data (i.e., 3D body geometry) 82 and the 3D face data (i.e., 3D face geometry) 81, which have been modified in accordance with the user. The created user avatar is a high-quality 3D avatar. Furthermore, character setup does not need to be performed on the data because the data is obtained by modifying the standard 3D face data 25 and the standard 3D body data 26, which have been retrieved from the 3D humanoid DB 22. That is, the texture data 15 and the 3D face data 81 generated on the basis of the user do not require a mapping procedure because links in the standard 3D face data 25 are used without change. Furthermore, there is no need to again undergo a procedure to combine the generated 3D face data 81 with the generated 3D body data 82. According to the present invention, since the time taken up by character setup and tuning is not required, the 3D avatar 80 resembling the user can be quickly created.

The animation unit 50 includes a face animation unit 51 for animating the face, a muscle and skinning unit 52 for animating muscle or the skin, and a body animation unit 53 for animating the body. The animation unit 50 applies motions to a created 3D avatar for a user. The animation unit 50 may implement a natural avatar behavior because it can apply an animation engine to the standard 3D face data 25 and the standard 3D body data 26 retrieved from the 3D humanoid DB 22. Furthermore, the animation unit 50 may directly use motion data retrieved from the motion DB 24.

The rendering unit 40 includes a BRDF renderer 41 for rendering humans and a Raytracer 42 for realistically rendering things The rendering unit 40 performs rendering in order to give a feeling of reality to a 3D avatar for a user. The rendering unit 40 renders the created 3D avatar 80 in high quality using a rendering engine. In the present invention, the rendering unit 40 may perform high-quality rendering, compared to existing graphics, because the rendering is performed using the BRDF data 16 and the subsurface scattering data 17.

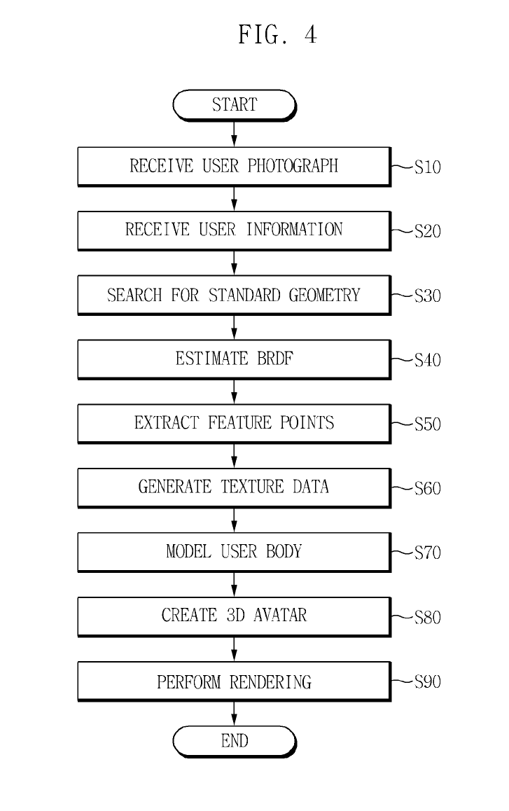

An example of the method of creating 3D avatars according to the present invention is described below with reference to FIG. 4.

FIG. 4 is a diagram illustrating the sequence of the method of creating 3D avatars according to the present invention. In the following description, elements identical to those shown in FIGS. 1 to 3 are assigned identical reference numerals.

First, the user body information acquisition unit 10 receives two sheets of user photographs from a user at step S10. The received user photographs 12 include front and side photographs of the face of the user. The received user photographs are stored in the face photograph DB 20.

Thereafter, the user body information acquisition unit 10 receives the user information 13 from the user at step S20. The user information includes the user's height and weight. The avatar creation unit 30 searches the 3D humanoid DB 23 for a standard 3D face geometry 25 and a standard 3D body geometry 26 for a 3D avatar on the basis of the received user information (i.e., body information (i.e., height and weight)) at step S30. That is, the avatar creation unit 30 searches the 3D humanoid DB 22 for data closest to the user's photographs and information from among predetermined standard geometry data, and loads the retrieved data.

Thereafter, the avatar creation unit 30 searches the BRDF DB 21 for a BRDF value closest to a skin tone appearing in the user photographs, and loads the retrieved BRDF value at step S40. Here, the avatar creation unit 30 also loads the subsurface scattering data 17 from the BRDF DB 21.

Once the standard 3D face and body geometries 25 and 26 are prepared on the basis of the BRDF data 16, the subsurface scattering data 17, the face photographs 12 and the user information 13 for the user, the avatar creation unit 30 starts to create a 3D avatar which resembles the user.

First, the avatar creation unit 30 extracts the feature points of the face on the basis of the face photographs 12 at step S50. Thereafter, the avatar creation unit 30 generates the texture data 15, mapped to the face of the 3D avatar, on the basis of the extracted feature points at step S60. As described above, the texture data is generated by calculating the difference between the extracted feature points and feature points extracted from texture data which is used in the standard 3D face data 25 retrieved from the 3D humanoid DB 22.

Thereafter, the avatar creation unit 30 scales up or down the standard 3D body data 26, selected on the basis of the user information, in accordance with the user's height and weight. Thereafter, the avatar creation unit 30 generates the 3D face data 81 for the user by modifying the standard 3D face data 25 at step S70.

Thereafter, the avatar creation unit 30 creates a user avatar by combining the 3D body data 82 and the 3D face data 81, which have been modified on the basis of the user, at step S80.

Here, the animation unit 50 applies face animation and muscle or body animation to the generated 3D avatar for the user. Furthermore, the rendering unit 40 renders the generated high-quality 3D avatar 80 at step S90.

As described above, according to the present invention, 3D technology is used, and an avatar creation process has been improved upon. Accordingly, there is an advantage in that user 3D avatars that are higher in quality than avatars provided by existing games or Internet sites may be quickly created. Furthermore, there is an advantage in that the high cost and long production time, occurring when the existing 3D technology is used, can be significantly reduced.

Furthermore, according to the present invention, in 3D UCC or Internet 3D virtual world which will be generalized in the future, a 3D avatar resembling a user may be quickly created. Thus, it is expected that the present invention will be actively used in such application fields. Furthermore, it is expected that the present invention will be expanded to fields, such as the digital home, e-commerce, telemetics and digital broadcasting fields, in addition to the entertainment field.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of creating a three-dimensional (3D) avatar, comprising:
receiving body information of a user and storing the body information in a DataBase (DB); and
creating a 3D avatar for the user by modifying standard data, predetermined based on body information about various persons, on a basis of the body information of the user.

2. The method as set forth in claim 1, further comprising searching the DB for standard data corresponding to the user and selected from all the standard data predetermined based on body information about various persons and stored in the DB, based on the body information of the user.

3. The method as set forth in claim 1, wherein the body information of the user comprises user information about one or more of a photograph, gender, height and weight of the user.

4. The method as set forth in claim 1, wherein the standard data comprises additional data which are at least one of 3D geometry, a texture map, a Bidirectional Reflectance Distribution Function (BRDF), and subsurface scattering data.

5. The method as set forth in claim 1, wherein the creating the 3D avatar comprises:
modeling a face of the 3D avatar for the user using standard data for a face, selected from among the standard data, based on the body information of the user; and
modeling a body of the 3D avatar for the user using standard data for a body, selected from among all the standard data, based on the body information of the user.

6. The method as set forth in claim 5, wherein the modeling the face comprises:
extracting feature points of a face of the user based on face photographs of the user;
generating texture data of the user to be mapped to the face of the 3D avatar based on the extracted feature points of the face; and
comparing the texture data of the user with the standard data for the face and generating the face of the 3D avatar for the user by modifying the standard data for the face based on a result of the comparison.

7. The method as set forth in claim 5, wherein the modeling the body comprises generating the body of the 3D avatar for the user by modifying the standard data for the body based on the height and weight of the user.

8. The method as set forth in claim 6, wherein the comparing the texture data of the user with the standard data for the face comprises generating the face of the 3D avatar for the user by calculating a difference between the extracted feature points of the face and texture data used in the standard data for the face and modifying the standard data for the face based on the difference.

9. The method as set forth in claim 6, wherein the generating texture data comprises calculating a difference between the feature points of the face and texture data used in the standard data for the face and generating the texture data of the user based on the difference.

10. The method as set forth in claim 1, further comprising applying motions to the 3D avatar for the user.

11. The method as set forth in claim 1, further comprising performing rendering in order to give a feeling of reality to the 3D avatar for the user.

12. An apparatus for creating a 3D avatar, comprising:
a user body information acquisition unit for receiving body information of a user and storing the body information in a DataBase (DB); and
an avatar creation unit for creating a 3D avatar for the user by modifying standard data, predetermined based on body information about various persons and stored in the DB, based on the body information of the user.

13. The apparatus as set forth in claim 12, wherein the avatar creation unit searches the DB for standard data corresponding to the user, selected from among all the standard data predetermined based on body information about various persons and stored in the DB, based on the body information of the user.

14. The apparatus as set forth in claim 12, wherein the body information of the user comprises user information about one or more of a photograph, gender, height, and weight of the user.

15. The apparatus as set forth in claim 12, wherein the standard data comprises additional data which are at least one of 3D geometry, a texture map, a BRDF, and subsurface scattering data.

16. The apparatus as set forth in claim 12, wherein the avatar creation unit comprises:
a face modeling unit for modeling a face of the 3D avatar for the user by using standard data for a face, selected from among all the standard data, based on the body information of the user; and
a body modeling unit for modeling a body of the 3D avatar for the user by using standard data for a body, selected from among all the standard data, based on the body information of the user.

17. The apparatus as set forth in claim 16, wherein the face modeling unit extracts feature points of a face of the user based on face photographs of the user, generates texture data of the user to be mapped to the face of the 3D avatar based on the extracted feature points of the face, compares the texture data of the user with the standard data for the face, and generates the face of the 3D avatar for the user by modifying the standard data for the face based on a result of the comparison.

18. The apparatus as set forth in claim 16, wherein the body modeling unit generates the body of the 3D avatar for the user by modifying the standard data for the body based on the height and weight of the user.

19. The apparatus as set forth in claim 12, further comprising an animation unit for applying motions to the 3D avatar for the user.

20. The apparatus as set forth in claim 12, further comprising a rendering unit for performing rendering in order to give a feeling of reality to the 3D avatar for the user.
